(19) United States
(12) Patent Application Publication
(10) Pub. No.: US 2016/0227276 A1
(43) Pub. Date: Aug. 4, 2016

(54) INTELLIGENT TELEVISION OPERATION SYSTEM

(71) Applicants: ACADEMY OF BROADCASTING SCIENCE. SARFT, Beijing (CN); ORIENTAL CABLE NETWORK CO., LTD., Shanghai (CN); JIANGSU BROADCASTING CABLE INFORMATION NETWORK CORP. LTD., Jiangsu (CN); ZTE CORPORATION, Guangdong (CN)

(72) Inventors: Feng ZOU, Beijing (CN); Zhifan SHENG, Beijing (CN); Delin CHEN, Beijing (CN); Xiaoyan XIA, Shanghai (CN); Liuzhong XUE, Nanjing (CN); Wei XIE, Beijing (CN); Hua JIANG, Shenzhen (CN); Jinlin WANG, Beijing (CN); Yimin BAI, Shanghai (CN); Qianrong WAN, Shanghai (CN); Sheng'an SUN, Nanjing (CN); Jigang WANG, Shenzhen (CN); Peng SUN, Beijing (CN); Liang TANG, Shanghai (CN); Dingjing ZHANG, Beijing (CN); Dongfei WANG, Beijing (CN); Mingmin WANG, Shanghai (CN); Wei WANG, Nanjing (CN); Guangtao FU, Beijing (CN); Xiaoyu LI, Beijing (CN); Liangfu ZHAO, Beijing (CN); Zheng LI, Beijing (CN); Wei BAI, Beijing (CN); Ying WANG, Beijing (CN)

(73) Assignees: Academy of Broadcasting Science, SARFT, Beijing (CN); Oriental Cable Network Co., Ltd., Shanghai (CN); JIANGSU BROADCASTING CABLE INFORMATION NETWORK CORP. LTD., Nanjing (CN); ZTE CORPORATION, Shenzhen (CN); Institute of Acoustics, Chinese Academy of Sciences, Beijing (CN); Liantong Network Communication Technology Inc. (Shanghai), Shanghai (CN)

(21) Appl. No.: 15/021,175

(22) PCT Filed: Sep. 10, 2014
(86) PCT No.: PCT/CN2014/086207

§ 371 Date: Mar. 10, 2016

(30) Foreign Application Priority Data
Sep. 10, 2013 (CN) 201310410141.6

(51) Int. Cl. H04N 21/443; H04N 21/81

(52) U.S. Cl. CPC H04N 21/4438; H04N 21/818

(57) ABSTRACT

The present invention relates to an intelligent television operation system, comprising an application frame layer combining and repackaging each component interface and logic of component layer to simplify reusing mechanism of application for components of the component layer; an application execution environment layer providing execution explaining environment of application codes; a component layer comprising a digital television-associated component for supporting an intelligent television application, wherein each component provides a standard universal component interface for the application frame layer; a hardware abstraction layer performing abstraction on hardware functions of Linux core layer, hiding hardware interface details and providing virtual hardware platform to provide unified interface for the component layer, whereby the component layer is hardware-irrelevant and transplanting on multiple platforms is facilitated; and a Linux core layer managing process, managing memory, realizing network protocol and providing drive program for hardware platform of a intelligent television.

### TECHNICAL FIELD

The present invention relates to the field of application of computers, in particular to the field of an operation system and especially an intelligent television operation system.

### BACKGROUND ART

At present, due to fast development of a digital information technology, a broadcasting and television network is fast evolved to the next generation broadcasting and television network, a telecommunication network is fast evolved to a broadband communication network, and the Internet is fast evolved to the next generation Internet. In addition, in an evolution process, the three networks tend to be consistent in technological function and identical in service scope, and the networks tend to interconnection, intercommunication and resource sharing, which may respectively provide various services such as broadcasting and television, voice and data services for users and become a network integrated by the afore-mentioned three networks.

Quick development of the integration of the three networks of the broadcasting, television and network requires that the digitalization, networking and intelligentization of the television need to be accelerated, and innovation and deployment of a new service type of the integration of three networks need to be accelerated. It is also required that a television terminal should not only be able to receive a traditional channelized television program, but also to play, on demand, an interactive video broadcasting program, receive an integrated novel television program with integration characteristics of the television, communication and Internet, and to realize intelligent cross-screen switching of the integrated television services among various terminals in different forms. All these requirements need to change the condition of over simple functions of the existing television terminals and realize the leap from televisions with simple functions to intelligently integrated television terminals, just like the leap of mobile phones from Feature Phones to Smart Phones.

In order to realize intelligent television terminals, it is necessary to change the current situation of binding between service application software of the digital television terminals with hardware platforms. Specifically, the following situation should be changed: for every increased service application of the existing digital television terminal, the software of the terminal must be upgraded, so that development and deployment of the service application does not depend on the software/hardware platform at a receiving terminal. In other words, the same type of receiving terminal should be capable of executing applications developed by different service/content providers, and the same application should be capable of being operated on different software/hardware platforms, whereby the capability of supporting the increasingly diverse digital television integration service is realized. Meanwhile, it is also required that like the smart phone, while ensuring safety, the digital television terminal should be capable of downloading various different third party application software from an integration service application store or service platform. Such third party application software comprises diverse applications, such as Angry Bird on the Android Application Store, and innovated digital television integration service such as social television, video communication and Internet television, thus continuously enriching terminal functions and enhancing user experience.

An intelligent television operation system (TVOS) is a necessary key technology of the intelligent television terminal.

### SUMMARY

In order to solve above problems, the present invention provides an intelligent television operation system, of which a software structure comprises an application frame layer 502, an application execution environment layer 503, a component layer 504, a hardware abstraction layer 505 and a Linux core layer 506, wherein the application frame layer 502 is configured to combine and repackage each component interface and logic of the component layer so as to simplify a reusing mechanism of the application for the components of the component layer; the application execution environment layer 503 is configured to provide an execution explaining environment of application codes; the component layer 504 comprises a digital television-associated component which is configured to support an intelligent television application, and each component provides a standard universal component interface for the application frame layer so as to keep an exposed interface of the application frame layer unchanged during component replacing; the Linux core layer 506 is configured to manage a process, manage a memory, realize a network protocol and provide a drive program for a hardware platform of the intelligent television; and the hardware abstraction layer 505 is configured to perform abstraction on hardware functions of the Linux core layer, hide hardware interface details and provide a virtual hardware platform so as to provide a unified interface for the component layer, whereby the component layer is hardware-irrelevant and transplanting on multiple platforms is facilitated.

In addition, the software structure further comprises an application layer 501, which is configured to realize various applications including Java applications and Web applications, and the application is in a software or file form and realizes all or part of functions of one service. Particularly, the application is a system application issued together with an operation system.

The digital television-associated component in the component layer 504 comprises one or a combination of the following components:

a live broadcasting television component, configured to provide core function software for the functions of a traditional digital television application, including carousel parsing, DSMCC parsing, PSI/SI parsing and demultiplexing;

an interactive television component, configured to support a corresponding software module based on a bidirectional network interactive audio and video service, including an interactive television application software module supporting Video-On-Demand (VOD), True Video On Demand (TVOD/TVS), and interactive video live broadcasting; and

a CA component, configured to acquire CA scrambling information from a scrambling stream, parse a scrambling controlled word, and acquire CA authorization information from a program stream to control the broadcasting authorization of a scrambled program.

The component layer 504 further comprises a network communication-associated component, configured to provide an Internet protocol and parsing of various network protocol-based communication service protocols. The network communication-associated component comprises one or a combination of the following components:

a network protocol component, configured to provide protocol support for network-associated various application development;

a family interconnection component, configured to interconnect respective devices in a family by a family interconnection protocol, realize dynamic finding and control of the devices and support coordinated work among respective devices; and

a communication component, configured to perform visible communication service-associated interaction and media transceiving managing and realize VoIP and intelligent television application-based unilateral or multilateral audio and video direct communication.

The component layer 504 further comprises a device management-associated component, configured to perform remote configuration managing on a user terminal by an operator. The device management-associated component comprises one or a combination of the following components:

a terminal managing component, configured to perform terminal remote network configuration, service configuration, query of terminal application installation information, service ordering and installation, and product version upgrading; and

a device managing component, configured to perform unified management of built-in or external devices of the intelligent television.

The component layer 504 further comprises a man-machine interaction-associated component, configured to realize local man-machine interaction between a user and the terminal. The man-machine interaction-associated component comprises one or a combination of the following components:

a man-machine interaction component, configured to provide various means for the user to interact with the devices; and

a UI component, configured to realize distribution processing of various graphical controls and window events required by UI development and provide support for UI development of applications.

The component layer 504 further comprises a media processing-associated component, configured to realize play control of a multimedia stream or file. The media processing-associated component comprises one or a combination of the following components:

an AV setting component, configured to provide audio and video parameter acquisition and setting; and

a media processing component, configured to perform audio and video media playing, collecting, inputting and associated functions.

In addition, the component layer 504 further comprises a window managing component, configured to provide functions including window adding and removing, window layout drawing, animation effect of window switching, focus switching and window positioning and rotating.

The component layer 504 further comprises an application management-associated component, configured to realize life period management of applications installed in the terminal. The application management-associated component comprises one or a combination of the following components:

an application signaling component, configured to realize the interaction with an operation front end, report an application life period control command sent from an operator to an application managing component, and perform software upgrade detection;

the application managing component, configured to execute starting, scheduling and life period management of the application as well as message distribution among the applications; and

an installation package managing component, configured to be in charge of the installation and uninstallation management of the application of the intelligent television terminal, and provide installation package-associated parsing and digital signature verification.

The component layer 504 further comprises a graphics library component, configured to perform drawing, rendering and displaying of graphic elements as well as window managing.

The component layer 504 further comprises a system management-associated component, configured to provide overall and system-level management of a software system. The system management-associated component comprises one or a combination of the following components:

a tool component, configured to provide an auxiliary tool class library for application development;

a language managing component, configured to provide region-associated tool support including currency, language and time;

a file managing component, configured to provide unified management for file access and reading and writing operations for the applications, shield difference of different file systems and realize access control;

a content managing component, serving as a unique data sharing means among the applications, and configured to store and retrieve data and provide a data access interface for other applications; and

an account number managing component, configured to manage services of different account numbers, such that different applications share one service account.

The component layer 504 further comprises a WebKit component, configured to perform parsing, presentation and operation processing on a Web page developed based on an HTML and Java Script languages.

Drivers provided by the Linux core layer comprise a high frequency head driver, a remote control driver, a front panel driver, a television display screen driver and a safety chip driver.

The drivers provided by the Linux core layer 506 further comprise a Bluetooth driver, a network card driver, a Wifi driver, a somatosensory device driver, a keyboard driver, a camera driver, a file system driver, a storage driver, a USB driver, an audio and video driver and a power source management driver.

The application frame layer 502 comprises a Java application frame and a Web application frame, the Java application frame comprises a Java application programming interface including a JSR 218 interface, a JSR 219 interface, a JSR 217 interface, a JSR 118 interface and an extended Java interface; and the Web application frame comprises a Web application programming interface including an HTML5 interface, a JS1.5 interface and an extended JS interface.

In addition, the application frame layer 502 further comprises a multi-application intelligent adaptation mechanism, configured to perform compatibility and adaption to an application developed aiming at other intelligent operation systems.

The application frame layer 502 calls an exposed standard universal component interface of a component by a Java Native Interface (JNI) or a Java Script Native Interface (JSNI).

Particularly, the application execution environment layer 503 comprises a Java application execution environment and a Web application execution environment, the Java application execution environment comprises a Java virtual machine and a Java core class library; the Web application execution environment adopts a WebKit-based Web engine; and the Java application execution environment and the Web application execution environment operate independently.

In addition, the software structure of the operation system further comprises a system and resource management mechanism 507, configured to perform operation system managing and scheduling, implement managing of finding and downloading, loading operation and switching scheduling of the terminal application and the managing and scheduling of hardware and software resource of the terminal, and manage an execution engine and function components of the operation system. In addition, the software structure further comprises a safety mechanism 508, configured to perform a full process safety protection, a safety maintenance and control and a system robustness safety guarantee from application issuing and application loading to operating of an application. The system robustness safety guarantee is realized by the following processing: performing system monitoring, abnormality finding and abnormality processing, finding and recovering errors in the system in a timely manner, effectively recycling resources occupied by an abnormal process, preventing system breakdown caused by abnormal system operations, and realizing system safety upgrading in cooperation with a safety chip and a safety Loader.

Hence, after the digital television receiving terminal is provided with the intelligent television operation system according to the present invention, interoperability of the application is capable of being improved, namely, the same terminal is capable of operating the applications developed by different application providers and the same application is capable of being operated on different terminals.

The additional aspects and advantages of the present invention will be partially given in following description, and part of the additional aspects and advantages will become obvious in following description or known through practice of the present invention.

### BRIEF DESCRIPTION OF THE DRAWINGS

The above and/or additional aspects and advantages of the present invention will become obvious and easily understood in combination with the description of following drawings on embodiments, wherein,

FIG. 1 illustrates an intelligent television operation system model according the present invention;

FIG. 2 illustrates a context and an interface schematic with the periphery of the intelligent television operation system according to the present invention in a digital television receiving terminal;

FIG. 3 illustrates a context of the intelligent television operation system according to the present invention in the whole Next Generation Broadcasting (NGB) Network;

FIG. 4 illustrates an input/output model of a digital television receiving terminal supported by the intelligent television operation system;

FIG. 5 illustrates a software structure of an intelligent television operation system according to the embodiments of the present invention.

### DETAILED DESCRIPTION OF THE EMBODIMENTS

Embodiments of the present will be described in detail, examples of the embodiments are shown in the drawings, wherein, and from beginning to end, identical or similar numbers represent the same or similar elements or the elements with same or similar functions. The embodiments described by reference drawings are exemplary, and merely intend to explain rather than limit the present invention. The disclosure below provides many different embodiments or examples to realize different structures of the present invention. In order to simplify the disclosure of the present invention, parts and settings of specific examples are described hereinafter. Certainly, they are only exemplary and do not aim to limit the present invention. In addition, the present invention is capable of repeating reference numbers and/or letters in different examples. Such repeat aims for simplification and clarification and does not indicate a relation between discussed various embodiments and/or settings.

An Operation System (OS) is system software, configured to manage all resources (including hardware, software and data resources) of a computer system, control program operations, improve man-machine interfaces, provide support for other application software, and the like. A television operation system is operation system software operating on a digital television receiving terminal, which may be a set top box, an all-in-one machine or other forms.

The intelligent television operation system structure provided by the present invention is a system software set which operates on an embedded digital television receiving terminal, and is configured to carry and operate television-associated services, control other programs to operate, manage system resource and provide an operation interface for a user.

According to the requirements of the Next Generation Broadcasting (NGB) Network, the intelligent television operation system requires to have the functions of basic services, including: managing and configuring memory, deciding the supply-demand priority of the system resource, controlling input and output devices, operating a network, managing a file system, supporting downloading and operation of the terminal application, supporting full life period management of the application from development, test, deployment downloading to operation and resource scheduling managing, providing a safety operation environment and function component support for the application, isolating the application development from a terminal platform, accelerating the development and deployment of the application and optimizing the operation experience of the television application. Further, a third party service provider should be able to develop applications based on the API provided by the intelligent television operation system and submit to application shops after testing and authentication to allow the user to install and operate, so as to enrich digital television service and enhance user experience.

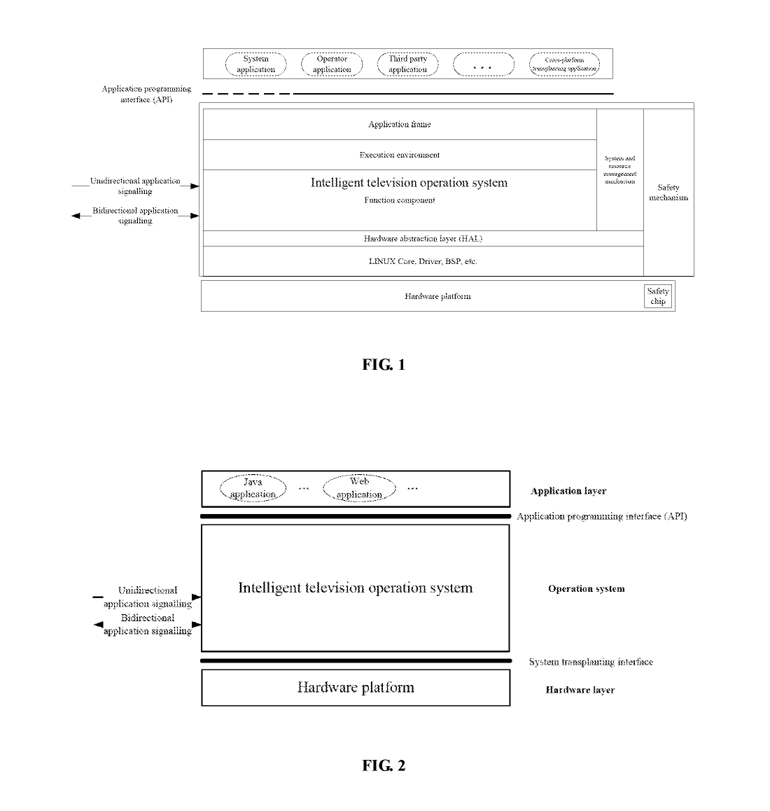

FIG. 1 illustrates an intelligent television operation system model according to the present invention, which comprises a software body under an application layer on a hardware platform and a system application embedded in the operation system.

FIG. 2 illustrates a context and an interface schematic with the periphery of the intelligent television operation system according to the present invention in a digital television receiving terminal.

As shown in the figures, the intelligent television operation system is positioned on the hardware layer and under the application layer of the receiving terminal, shields the difference of the hardware layer, provides a unified environment for operation of the application, and provides a complete and unified Application Programming Interface (API) for development of the application.

As shown in the figures, the intelligent television operation system and the periphery have three kinds of interfaces:

1, an application programming interface, namely an interface of the intelligent television operation system provided for an application developer;

2, a system transplanting interface, namely an interface of the intelligent television operation system requiring transplanting aiming at a specific hardware platform; and

3, an application signaling, namely an interface of the intelligent television operation system for interaction with an operation front end.

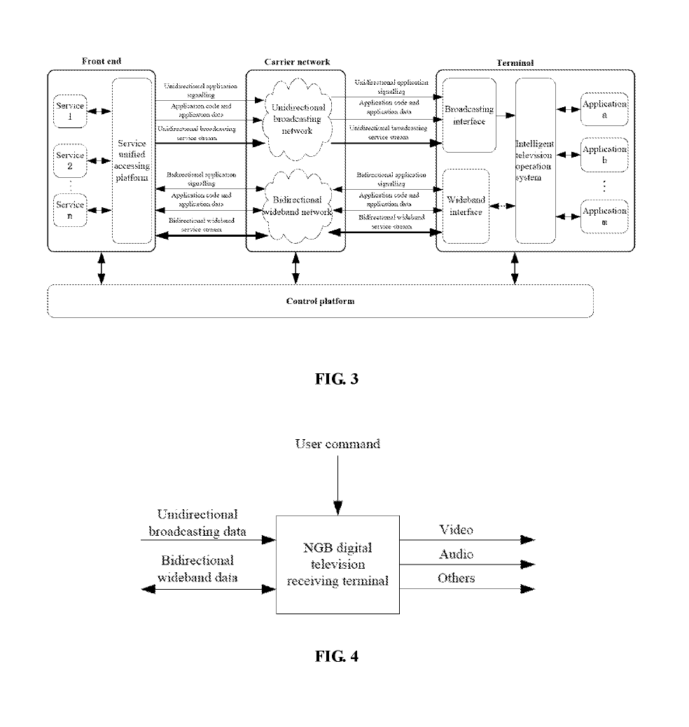

FIG. 3 further illustrates a context of the intelligent television operation system according to the present invention in the whole Next Generation Broadcasting (NGB) Network.

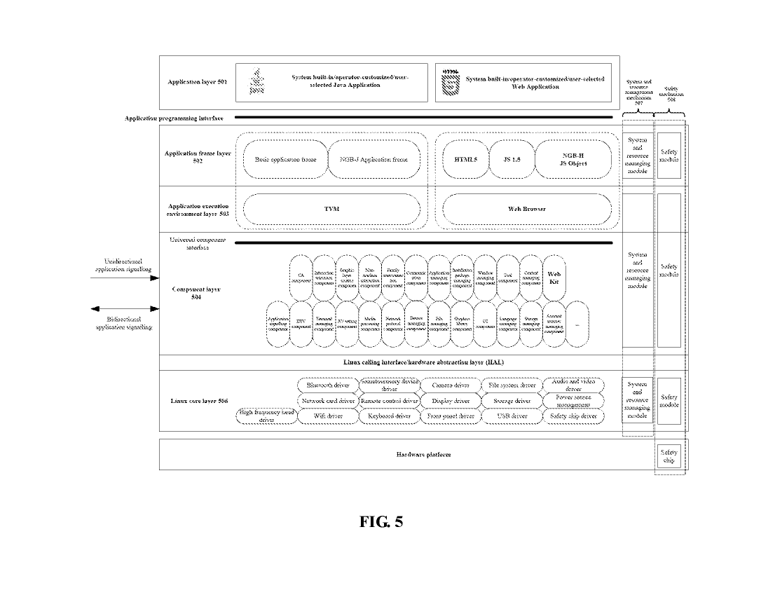

FIG. 4 illustrates a digital television receiving terminal and an input/output model thereof supported by the intelligent television operation system.

The digital television receiving terminal supported by the intelligent television operation system has the capabilities of receiving data from a bidirectional broadcasting network and/or a bidirectional wideband network, sending back and interacting data by the bidirectional wideband network, decompressing images, processing multimedia data, outputting aliased audio and video signals to a loudspeaker, a display and other output devices, and receiving and processing a user command sent from input devices such as a remote control, a keyboard and a mouse.

According to the requirements of the NGB Network, the applications supported by the intelligent television operation system is capable of being divided into program content-associated type applications and independent applications according to an incidence relation with the broadcasting program content; the program content-associated type applications are the applications associated with one or more broadcasting services or one or more broadcasting events in the broadcasting service, and selection or switching of the broadcasting service has influence on the life period and operation state of the application; the independent applications are the applications not associated with any broadcasting service, and the switching of the broadcasting service has no influence on the life period and operation state of the application.

On the other aspect, the applications may comprise Java applications and Web applications according to the type of a development technology, the Java applications are a joint name of the applications developed by adopting a Java programming language; and the Web applications are a joint name of the applications developed by adopting a Web technology such as an HTML technology, a JavaScript technology and a CSS technology.

According to above requirements, according to a first embodiment of the present invention, as shown in FIG. 5, there is provided an intelligent television operation system, comprising an application frame layer 502, an application execution environment layer 503, a component layer 504, a hardware abstraction layer 505 and a Linux core layer 506. In preferable embodiments, the intelligent television operation system further comprises an application layer 501.

The application layer 501 is configured to realize various applications including Java applications and Web applications, wherein the applications are in a software or file form and realize all or part of functions of one service. The applications are capable of being divided into system applications, operator customized applications and user-selected applications according to the source. The applications provided by the intelligent television operation system are the system applications issued along with the operation system.

The application frame layer 502 is configured to combine and repackage each component interface and logic of the component layer so as to simplify a reusing mechanism of the application for the components of the component layer. Particularly, the application frame layer 502 comprises a Java application frame and a Web application frame, the Java application frame comprises a Java application programming interface including a JSR 218 interface, a JSR 219 interface, a JSR 217 interface, a JSR 118 interface and an extended Java interface; and the Web application frame comprises a Web application programming interface including an HTML5 interface, a JS1.5 interface and an extended JS interface. The Java application frame calls components in the component layer by a Java Native Interface (JNI), and the Web application frame calls components in the component layer by a Java Script Native Interface (JSNI), wherein, the extended Java interface defines an NGB-J interface supporting the digital television applications. The extended JS interface defines an NGB-HJS object supporting the digital television applications.

In addition, preferably, the application frame layer further comprises a multi-application intelligent adaptation mechanism, configured to perform compatibility and adaption to an application developed aiming at other intelligent operation systems. The multi-application intelligent adaptation mechanism keeps the component layer of the intelligent television operation system unchanged and performs different combinations and packages on the components at the application frame layer according to the requirements of the application programming interface of a target operation system, thus realizing the application programming interface required by the target operation system and realizing the application compatibility of the target operation system. The application frame layer calls an exposed standard universal component interface of a component by a JNI or a JSNI.

The application execution environment layer 503 is configured to provide an execution explaining environment of application codes. The application execution environment layer 503 comprises a Java application execution environment and a Web application execution environment, the Java application execution environment comprises a Java virtual machine and a Java core class library; the Web application execution environment adopts a WebKit-based Web engine; and the Java application execution environment and the Web application execution environment operate independently. In the present embodiment, the Java application execution environment and the Web application execution environment operate independently and respectively exist independently, the Java application execution environment does not relay on the capability of the Web application execution environment, the Web application execution environment does not rely on the capability of the Java application execution environment, the life period of any application execution environment does not rely on the fact that whether other application execution environments are operated, and the ending of the life period of any application execution environment does not cause the ending of the life period of other applications.

The component layer 504 comprises a digital television-associated component which is configured to support an intelligent television application, and each component provides a standard universal component interface for the application frame layer so as to keep the exposed interface of the application frame layer 502 unchanged during component replacing.

Particularly, the digital television-associated component in the component layer 504 may comprise: a live broadcasting television component, configured to provide core function software for the functions of a traditional digital television application, including carousel parsing, DSMCC parsing, PSI/SI parsing and demultiplexing; an interactive television component, configured to support a corresponding software module based on a bidirectional network interactive audio and video service, including an interactive television application software module supporting Video-On-Demand (VOD), True Video On Demand (TVOD/TVS), and interactive video live broadcasting; and a CA component, configured to acquire CA scrambling information from a scrambling stream, parse a scrambling controlled word, and acquire CA authorization information from a program stream to control the broadcasting authorization of a scrambled program.

Certainly, in order to support other applications of the intelligent television, the component layer may further comprise other components besides the digital television-associated component.

For example, the operation system may comprise all or part of component sets as follows: a network communication-associated component, a device management-associated component, a man-machine interaction-associated component, a window management-associated component, an application management-associated component, a graphic display-associated component, a system management-associated component and a browser-associated component.

Preferably, the network communication-associated component is configured to provide a network protocol and parsing of various network protocol-based communication service protocols. Specifically, associated components may comprise one or a combination of the following components: a family interconnection component, configured to interconnect respective devices in a family by a family interconnection protocol, realize dynamic finding and control of the devices and support coordinated work among respective devices; a network protocol component, configured to provide protocol support for network-associated various application development; and a communication component, configured to perform visible communication service-associated interaction and media transceiving managing and realize VoIP and intelligent television application-based unilateral or multilateral audio and video direct communication.

The device management-associated component is configured to perform remote configuration managing on a user terminal by an operator. Specifically, associated components may comprise one or a combination of the following components: a terminal managing component, configured to perform terminal remote network configuration, service configuration, query of terminal application installation information, service ordering and installation, and product version upgrading; and a device managing component, configured to perform unified management of built-in or external devices of the intelligent television.

The man-machine interaction-associated component is configured to realize local man-machine interaction between a user and the terminal. Specifically, associated component layer may comprise one or a combination of the following components: a man-machine interaction component, configured to provide various means for the user to interact with the devices; and a UI component, configured to realize distribution processing of various graphical controls and window events required by UI development and provide support for UI development of applications.

The media processing-associated component is configured to realize play control of a multimedia stream or file. Specifically, associated component layer may comprise one or a combination of the following components: an AV setting component, configured to provide audio and video parameter acquisition and setting; and a media processing component, configured to perform audio and video media playing, collecting, inputting and associated functions.

The window managing component is configured to provide functions including window adding and removing, window layout drawing, animation effect of window switching, focus switching and window positioning and rotating.

The application management-associated component is configured to realize life period management of applications installed in the terminal. Specifically, associated components may comprise one or a combination of the following components: an application signaling component, configured to realize the interaction with an operation front end, report an application life period control command sent from an operator to an application managing component and perform software upgrade detection; an application managing component, configured to execute starting, scheduling and life period management of the application as well as message distribution among the applications; and an installation package managing component, configured to be in charge of the installation and uninstallation management of the application of the intelligent television terminal, and provide installation package-associated parsing and digital signature verification.

The graphic display component may be a graphics library component, configured to perform drawing, rendering and displaying of graphic elements as well as window managing.

The system management-associated component is configured to provide overall and system-level management of a software system. Specifically, associated components may comprise one or a combination of the following components: a tool component, configured to provide an auxiliary tool class library for application development; a language managing component, configured to provide region-associated tool support including currency, language and time; a content managing component, serving as a unique data sharing means among the applications, and configured to store and retrieve data and provide a data access interface for other applications; a file managing component, configured to provide unified management for file access and reading and writing operations for the applications, shield difference of different file systems and realize access control; and an account number managing component, configured to manage services of different account numbers, such that different applications share one service account.

The browser-associated component specifically may comprise a WebKit component, configured to perform parsing, presentation and operation processing on a Web page developed based on an HTML language and a JAVA Script language.

The Linux core layer 506 is configured to manage a process, manage a memory, realize a network protocol and provide a drive program for a hardware platform of the intelligent television.

The hardware drivers provided herein comprise a high frequency head driver, a remote control driver, a front panel driver, a television display screen driver and a safety chip driver for supporting digital television services. In addition, the hardware drivers may further comprise a Bluetooth driver, a network card driver, a Wifi driver, a somatosensory device driver, a keyboard driver, a camera driver, a file system driver, a storage driver, a USB driver, an audio and video driver, and a power source management driver.

The hardware abstraction layer 505 is configured to perform abstraction on the hardware functions, hide hardware interface details and provide a virtual hardware platform so as to provide a unified interface for the component layer, whereby the component layer is hardware-irrelevant and transplanting on multiple platforms is facilitated.

In addition, according a preferable embodiment, the software structure of the intelligent operation system of the present invention further comprises a system and resource management mechanism 507, configured to perform operation system managing and scheduling, implement managing of finding and downloading, loading operation and switching scheduling of the terminal application and the managing and scheduling of hardware and software resource of the terminal, and manage an execution engine and function components of the operation system. According to hierarchical functions of the software structure of the operation system and the characteristics of a programming language, the system and resource management mechanism 507 respectively plants a resource managing module into the application frame layer, the execution environment and component layer and the Linux core layer, these resource managing modules firstly perform its own functions and are in charge of the resource managing work of the software layers where the resource managing modules are positioned, meanwhile these resource managing modules are one organic whole, communicate with one another and cooperatively work to realize the efficient resource managing of the whole operation system.

In addition, according to another preferable embodiment, the software structure of the intelligent operation system of the present invention further comprises a safety mechanism 508, configured to perform a full process safety protection, a safety maintenance and control and a system robustness safety guarantee from application issuing and application loading to operating of an application. The system robustness safety guarantee is realized by the following processing: performing system monitoring, abnormality finding and abnormality processing, finding and recovering errors in the system in a timely manner, effectively recycling resources occupied by an abnormal process, preventing system breakdown caused by abnormal system operations, and realizing system safety upgrading in cooperation with a safety chip and a safety Loader. According to hierarchical functions of the software structure of the operation system and the characteristics of a programming language, the safety mechanism 508 respectively plants a safety module into the application frame layer, the execution environment and component layer and the Linux core layer, these safety modules firstly perform its own functions and are in charge of the safety managing of the software layers where the safety modules are positioned, meanwhile these safety modules are one organic whole, communicate with one another and cooperatively work to realize the efficient safety managing of the whole operation system.

Hence, the intelligent television operation system of the present invention at least has three following beneficial effects:

(1) as an operation system operated on an embedded platform, the intelligent television operation system has the functions of common operation systems;

(2) the operation system of the present invention is capable of bearing television-associated services, such as live television, true video on demand, video on demand and the like; and

(3) the intelligent television operation system can enable users to download and install applications developed by third party service providers by themselves.

Hence, after the digital television receiving terminal is provided with the intelligent television operation system according to the present invention, interoperability of the application is capable of being improved. That is, the same terminal is capable of operating the applications developed by different application providers and the same application is capable of being operated on different terminals.

Although exemplary examples and advantages thereof have been described in detail, it should be understood that under the condition of not departing from the spirit and a protection scope defined by the appended claims of the present invention, these embodiments can be subjected to various changes, substitutions and modifications. For other examples, those common skilled in the art can easily understand that the sequence of the process steps can be changed within the protection scope of the present invention.

In addition, the application scope of the present invention is not limited to the processes, mechanisms, manufacturing, material compositions, means, methods and steps of specific embodiments described in the description. From the disclosed content of the present invention, those common skilled in the art can easily understand that for the processes, mechanisms, manufacturing, material compositions, means, methods and steps which already exist or are about to be developed, they execute the functions approximately same as or acquire the results approximately same as those of the corresponding embodiments of the present invention, and can be applied according to the present invention. Therefore, the appended claims of the present invention aim to contain these processes, mechanisms, manufacturing, material compositions, means, methods and steps into the protection scope.

1. An intelligent television operation system, characterized in that a software structure thereof comprises an application frame layer, an application execution environment layer, a component layer, a hardware abstraction layer and a Linux core layer, wherein:
the application frame layer is configured to combine and repackage each component interface and logic of the component layer so as to simplify a reusing mechanism of for components of the component layer by an application;
the application execution environment layer is configured to provide an execution explaining environment of application codes;
the component layer comprises a digital television-associated component which is configured to support an intelligent television application, and each component provides a standard universal component interface for the application frame layer so as to keep an exposed interface of the application frame layer unchanged during component replacing;
the Linux core layer is configured to manage a process, manage a memory, realize a network protocol and provide a drive program for a hardware platform of the intelligent television; and
the hardware abstraction layer is configured to perform abstraction on hardware functions of the Linux core layer, hide hardware interface details and provide a virtual hardware platform so as to provide a unified interface for the component layer, whereby the component layer is hardware-irrelevant and thus transplanting on multiple platforms is facilitated.

2. The operation system according to claim 1, characterized in that the software structure further comprises an application layer which is configured to realize various applications comprising Java applications and Web applications, and the application is in a software or file form and realizes all or part of functions of a service.

3. The operation system according to claim 2, characterized in that the application is a system application issued along with the operation system.

4. The operation system according to claim 1, characterized in that the digital television-associated component comprises one or a combination of the following components:
a live broadcasting television component, configured to provide core function software for the functions of a traditional digital television application, including carousel parsing, DSMCC parsing, PSI/SI parsing and demultiplexing;
an interactive television component, configured to support a corresponding software module based on a bidirectional network interactive audio and video service, including an interactive television application software module supporting Video-On-Demand (VOD), True Video On Demand (TVOD/TVS), and interactive video live broadcasting; and
a CA component, configured to acquire, in real-time, CA scrambling information from a scrambling stream, parse a scrambling controlled word, and acquire CA authorization information from a program stream to control the broadcasting authorization of a scrambled program.

5. The operation system according to claim 1, characterized in that the component layer further comprises a network communication-associated component, configured to provide an Internet protocol and parsing of various Internet-protocol-based communication service protocols.

6. The operation system according to claim 5, characterized in that the network communication-associated component comprises one or a combination of the following components:
a network protocol component, configured to provide protocol support for network-associated various application development;
a family interconnection component, configured to interconnect respective devices in a family by a family interconnection protocol, realize dynamic finding and control of the devices and support coordinated work among respective devices; and
a communication component, configured to perform visible communication service-associated interaction and media transceiving managing and realize VoIP and intelligent television application-based unilateral or multilateral audio and video direct communication.

7. The operation system according to claim 1, characterized in that the component layer further comprises a device management-associated component, configured to perform remote configuration managing on a user terminal by an operator.

8. The operation system according to claim 7, characterized in that the device management-associated component comprises one or a combination of the following components:
a terminal managing component, configured to perform terminal remote network configuration, service configuration, query of terminal application installation information, service ordering and installation, and product version upgrading; and
a device managing component, configured to perform unified management of built-in or external devices of the intelligent television.

9. The operation system according to claim 1, characterized in that the component layer further comprises a man-machine interaction-associated component, configured to realize local man-machine interaction between a user and a terminal.

10. The operation system according to claim 9, characterized in that the man-machine interaction-associated component comprises one or a combination of the following components:
a man-machine interaction component, configured to provide various approaches and means for the user to interact with the devices; and
a UI component, configured to realize distribution processing of various graphical controls and window events required by UI development and provide support for UI development of applications.

11. The operation system according to claim 1, characterized in that the component layer further comprises a media processing-associated component, configured to realize play control of a multimedia stream or file.

12. The operation system according to claim 11, characterized in that the media processing-associated component comprises one or a combination of the following components:
an AV setting component, configured to provide audio and video parameter acquisition and setting; and
a media processing component, configured to perform audio and video media playing, collecting, inputting and associated functions.

13. The operation system according to claim 1, characterized in that the component layer further comprises a window managing component, configured to provide functions including window adding and removing, window layout drawing, animation effect of window switching, focus switching and window positioning and rotating.

14. The operation system according to claim 1, characterized in that the component layer further comprises an application management-associated component, configured to realize life period management of applications installed in a terminal.

15. The operation system according to claim 14, characterized in that the application management-associated component comprises one or a combination of the following components:
an application signaling component, configured to realize interaction with an operation front end, report an application life period control command sent from an operator to an application managing component and perform software upgrade detection;
the application managing component, configured to execute starting, scheduling and life period management of the application as well as message distribution among applications; and
an installation package managing component, configured to be in charge of the installation and uninstallation management of the application of the intelligent television terminal, and provide installation package-associated parsing and digital signature verification.

16. The operation system according to claim 1, characterized in that the component layer further comprises a graphics library component, configured to perform drawing, rendering and displaying of graphic elements as well as window managing.

17. The operation system according to claim 1, characterized in that the component layer further comprises a system management-associated component, configured to provide overall and system-level management of a software system.

18. The operation system according to claim 17, characterized in that the system management-associated component comprises one or a combination of the following components:
a tool component, configured to provide an auxiliary tool class library for application development;
a language managing component, configured to provide region-associated tool support including currency, language and time;
a file managing component, configured to provide unified management for file access and reading and writing operations for the applications, shield difference of different file systems and realize access control;
a content managing component, serving as a unique data sharing means among applications, and configured to store and retrieve data and provide a data access interface for other applications; and
an account number managing component, configured to manage services of different account numbers, such that different applications share one service account.

19. The operation system according to claim 1, characterized in that the component layer further comprises a WebKit component, configured to perform parsing, presentation and operation processing on a Web page developed based on HTML and Java Script languages.

20. The operation system according to claim 1, characterized in that drivers provided by the Linux core layer comprise a high frequency head driver, a remote control driver, a front panel driver, a television display screen driver and a safety chip driver.

21. The operation system according to claim 20, characterized in that the drivers provided by the Linux core layer further comprise a Bluetooth driver, a network card driver, a Wifi driver, a somatosensory device driver, a keyboard driver, a camera driver, a file system driver, a storage driver, a USB driver, an audio and video driver and a power source management driver.

22. The operation system according to claim 1, characterized in that the application frame layer comprises a Java application frame and a Web application frame, wherein the Java application frame comprises a Java application programming interface including a JSR 218 interface, a JSR 219 interface, a JSR 217 interface, a JSR 118 interface and an extended Java interface; and the Web application frame comprises a Web application programming interface including an HTML5 interface, a JS 1.5 interface and an extended JS interface.

23. The operation system according to claim 22, characterized in that the application frame layer further comprises a multi-application intelligent adaptation mechanism, configured to perform compatibility and adaption to an application developed aiming at other intelligent operation systems.

24. The operation system according to claim 23, characterized in that the application frame layer calls an exposed standard universal component interface of a component by a Java Native Interface (JNI) or a Java Script Native Interface (JSNI).

25. The operation system according to claim 1, characterized in that the application execution environment layer comprises a Java application execution environment and a Web application execution environment, wherein the Java application execution environment comprises a Java virtual machine and a Java core class library; the Web application execution environment adopts a WebKit-based Web engine; and the Java application execution environment and the Web application execution environment operate independently.

26. The operation system according to claim 1, characterized in that the software structure further comprises a system and resource management mechanism, configured to perform operation system managing and scheduling, implement managing of finding and downloading, loading operation and switching scheduling of a terminal application and the managing and scheduling of hardware and software resource of a terminal, and manage an execution engine and function components of the operation system.

27. The operation system according to claim 1, characterized in that the software structure further comprises a safety mechanism, configured to perform a full process safety protection, a safety maintenance and control and a system robustness safety guarantee from application issuing and application loading to operating of an application.

28. The operation system according to claim 27, characterized in that the system robustness safety guarantee is realized by the following processing: performing system monitoring, abnormality finding and abnormality processing, finding and recovering errors in the system in a timely manner, effectively recycling resources occupied by an abnormal process, preventing system breakdown caused by abnormal system operations, and realizing system safety upgrading in cooperation with a safety chip and a safety Loader.
